(19) United States
(12) Patent Application Publication
(10) Pub. No.: US 2010/0171480 A1
(43) Pub. Date: Jul. 8, 2010

(54) METHOD AND APPARATUS OF A UNIFIED CONTROL SOLUTION FOR BRIDGELESS POWER FACTOR CONTROLLERS AND GRID CONNECTED INVERTERS

(76) Inventors: Yang Ye, Mississauga (CA); Wenjiang Yu, Mississauga (CA)

Correspondence Address: Yang Ye, 2802-310 Burnhamthorpe Rd. W, Mississauga, ON, L5B4P9, CA

(21) Appl. No.: 12/349,504

(22) Filed: Jan. 6, 2009

(51) Int. Cl. G05F 1/10

(52) U.S. Cl. 323/283

(57) ABSTRACT

A unified control solution for both bridgeless power factor controllers and grid connected inverters is disclosed. Conventionally, the bridgeless power factor controllers and the grid connected inverters are controlled with different approaches. In the present invention, it is disclosed that the two kinds of applications can be controlled with one unified approach. With the disclosed method, one single integrated circuit can be made and be used in both applications. Firstly, a sample based controller is disclosed to derive the ac current reference from the ac voltage and the dc voltage. The ac current reference is forced to be proportional to the ac voltage. The proportion coefficient is derived from the dc voltage in such a way to keep the dc voltage constant. Furthermore, the coefficient is updated only once every half ac line cycle. So as long as the ac current follows the current reference, the dc voltage will be regulated to a constant, and the ac current will be pure sinusoidal. Secondly, a new current mode switching pattern is disclosed based on an improved hysteretic switching pattern. The disclosed switching pattern minimizes the number of switching event and removes the deadtime requirement without the risk of shoot through.

### BACKGROUND

1. Field of the Invention

The present invention relates to power electronics, and more particularly to a method and apparatus of a unified solution for bridgeless power factor controllers and grid connected inverters.

2. Background Information

Conventionally, the bridgeless power factor controllers and the grid connected inverters are controlled with different approaches. In both applications, it is essential to regulate the dc voltage to a constant and to control the ac side current to be in phase with the ac side voltage. The difference in the two applications is the direction of power, in the power factor controllers, the power direction is from the ac side to the dc side. In the inverters, the power direction is from the dc side to the ac side. In grid connected inverters, the control often involves DSP or microcontrollers. Complex algorithms have been developed to control the ac current and the dc voltage. It is preferred to have a unified, easy-to-use control solution which works for both power factor controller and grid connected inverter. In this way, the development cycle for both applications can be reduced. It is also desired to have a control solution which leads to better ac current waveform, less power dissipation, and higher reliability. The disclosed invention provides a solution to all those requirements.

### SUMMARY OF THE INVENTION

The embodiments of the present invention are directed to the general method and the implementation of the unified controller for both bridgeless power factor controllers and grid connected inverters. The control method involves two steps. The first step is to derive the ac side current reference from the ac side voltage and the dc side voltage. The second step is to regulate the ac side current to the current reference with minimal response time. The first step is based on the mathematical relationships between the ac side voltage, current, and the dc side voltage. It can be implemented with either hardware or software. The hardware implementation example has been provided, mainly based on the sample based controller. The software flow chart has also been provided. The second step may be implemented with all current mode full bridge controllers. In the present invention, a modified hysteretic switching pattern is disclosed. The disclosed switching pattern can minimize the switching event, avoid the usage of deadtime without the risk of shoot-through.

### BRIEF DESCRIPTION OF FIGURES

FIG. 1 is the general topology of single phase voltage source converter;

FIG. 2 shows the waveforms of ac side voltage and current and dc side voltage;

FIG. 3 is the control diagram of deriving ac current reference Iacref;

FIG. 4 is the block diagram showing the hardware implementation of ‘Sample Based Controller’ block in FIG. 3;

FIG. 5 is the software flow chart of ‘Sampled Based Controller’ block in FIG. 3;

FIG. 6 is the conventional hysteretic switching pattern for single phase converters;

FIG. 7 shows the disclosed switching pattern for power flow controller during positive half cycle of the ac voltage;

FIG. 8 shows the disclosed switching pattern for power flow controller during negative half cycle of the ac voltage;

FIG. 9 shows the disclosed switching pattern for grid connected inverter during positive half cycle of the ac voltage;

FIG. 10 shows the disclosed switching pattern for grid connected inverter during negative half cycle of the ac voltage;

FIG. 11 shows an alternate disclosed switching pattern for power flow controller during positive half cycle of the ac voltage;

FIG. 12 shows an alternate disclosed switching pattern for power flow controller during negative half cycle of the ac voltage;

FIG. 13 shows an alternate disclosed switching pattern for grid connected inverter during positive half cycle of the ac voltage;

FIG. 14 shows an alternate disclosed switching pattern for grid connected inverter during negative half cycle of the ac voltage;

FIG. 15 is the block diagram of the implementation of the disclosed switching pattern;

FIG. 16 is the complete IC block diagram for general bridgeless PFC circuit and/or grid connected inverter controller

### DETAILED DESCRIPTION OF THE PREFERRED EMBODIMENTS

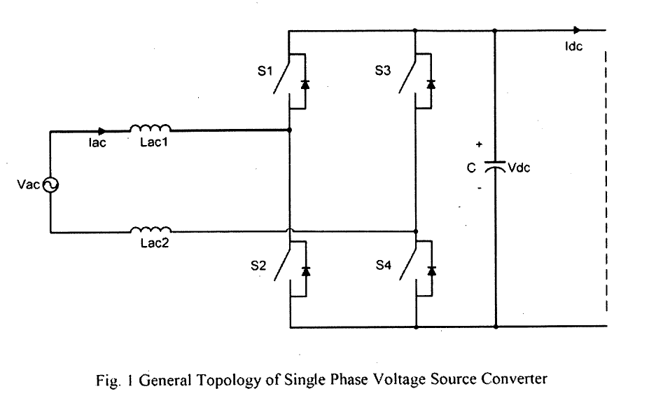

Both the bridgeless power factor controller and the grid connected inverter are converters connected to the power grid. FIG. 1 shows the general topology of the converter. S1, S2, S3, and S4 are general power semiconductors. Without losing generosity, they are drawn as ideal switches with anti-paralleled diodes. They can be MOSFET, or IGBT, or diode, whichever applicable. The ac source Vac is the voltage source with a stable RMS voltage level and a fixed frequency. Lac 1 and Lac2 are the interface inductors. C is the dc side bulk capacitor. The dc side voltage Vdc is to be regulated. In either power factor controller or inverter. Vdc must be regulated to a constant value. The ac side current must be a sinusoidal waveform with the same phase angle as the ac voltage. The only difference is that the current sense polarity of a power factor controller is the reverse of an inverter. In the following description, the reversal of the polarity is not explicitly emphasized. It is implied that whenever a power factor controller is mentioned, the current polarity is defined as positive if the current flows from the ac side to the dc side; and whenever an inverter is mentioned, the current polarity is defined as positive if the current flows from the dc side to the ac side.

The control of the general converter as shown in FIG. 1 includes two steps. The first step is to find out the ac side current reference, A ‘Sample Based Controller’ is disclosed as an effective and easy-to-implement controller. The second step is to find a way to let the actual ac current follow the current reference as quickly as possible, A new current mode switching pattern is disclosed to improve the waveform and reduce the losses.

### First Step: Find the ac Side Current Reference—‘Sample Based Controller’

Since the ac side current has to be in phase with the ac voltage, it is straightforward to make the ac current reference to be proportional to the ac voltage. The difficult part is how to derive the proportion coefficient, which determines the magnitude of the current. The magnitude of the current determines the amount of power being delivered. So the coefficient is supposed to be derived from the power requirement. In voltage source converter, the variation in the dc side voltage (Vdc in FIG. 1) reflects the relationship between ac side power and dc side power.

Assume the ac side voltage being

V_{sc}(t)=\sqrt{2}Vᵣₘₛ sin(ωt) (1)

Where Vac is the ac side voltage as shown in FIG. 1;
Vrms is the RMS voltage of Vac;
ω=2πf, f is the frequency of the ac side voltage; and
t is the time.

In steady state operation of the power factor controller, the current direction is from the ac side to the dc side, with the same phase angle of the ac voltage. Assume the RMS value of the current being Irms, so

I_{ac}(t)=\sqrt{2}Iᵣₘₛ sin(ωt) (2)

Where Iac is the ac side current as shown in FIG. 1, with the direction from the ac side to the dc side.

Assume under steady state, the dc side voltage is Vdc and dc side current is Idc, as shown in FIG. 1. Neglect the losses in the semiconductors, the inductor, and the wiring. The following set of power balance equations can be written.

$$\begin{matrix}{P}_{a c} ( t ) - \frac{d}{d t} {E}_{l} ( t ) = {P}_{d c} ( t ) + \frac{d}{d t} {E}_{c} ( t ) & ( 3 ) \\ {P}_{a c} ( t ) = {V}_{a c} ( t ) {I}_{a c} ( t ) & ( 4 ) \\ {P}_{d c} = {V}_{d c} ( t ) {I}_{d c} ( t ) & ( 5 ) \\ {E}_{1} ( t ) = \frac{1}{2} ( {L}_{a c 1} + {L}_{a c 2} ) {I}_{a c}^{2} ( t ) & ( 6 ) \\ {E}_{c} ( t ) = \frac{1}{2} {CV}_{d c}^{2} ( t ) & ( 7 )\end{matrix}$$

Where Pac(t) is the ac side instantaneous power; Pdc is the dc side power, which is a constant; El(t) is the total energy stored in the inductors Lac1 and Lac2; Ec(t) is the energy stored in the capacitor C; Lac1, Lac2, and C are the inductors and the dc side capacitor in FIG. 1.

From Equations (1)˜(7), the dc side voltage can be derived as

$${V}_{d c}^{2} ( t ) = {V}_{d c 0}^{2} + Δ Pt - \frac{\sqrt{{P}_{d c}^{2} + {Q}_{l}^{2}}}{ω C} sin ( 2 ω t - δ ) \qquad ( 8 )$$

Where: Vdc0 is the initial value of Vdc

$$Δ P = {V}_{r m s} {I}_{r m s} - {P}_{d c}$$

$${Q}_{l} = ω L {I}_{r m s}^{2}$$

$$L = {L}_{a c 1} + {L}_{a c 2}$$

$$tan δ = \frac{{Q}_{l}}{{P}_{d c}}$$

Equation (8) shows that
when ΔP=0, Vdc0 is the rms value of Vdc.
when ΔP=0, Vdc(t) varies periodically at double of the line frequency.
when ΔP>0, Vdc(t) will ramp up
when ΔP>0, Vdc(t) will ramp down
In practical, Q1<<Pdc. So when ΔP=0, Vdc(t) reaches Vdc0 almost at the same time when the ac side voltage reaches zero.

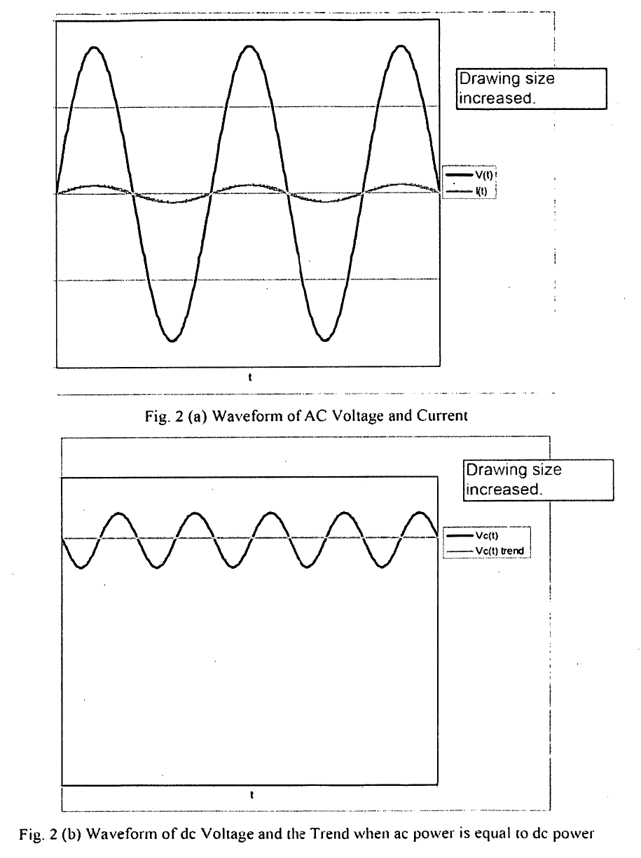

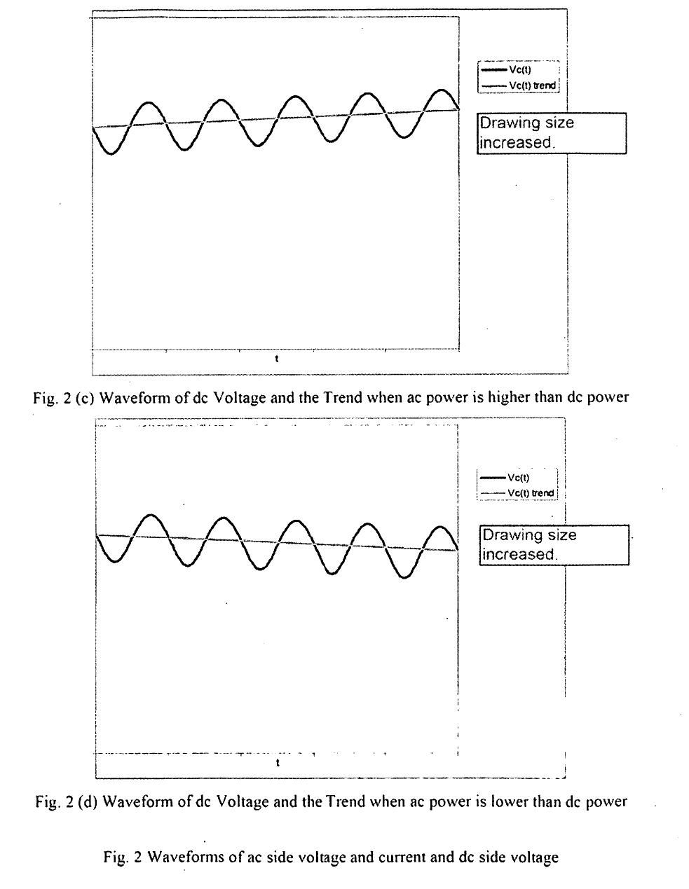

FIG. 2(a) shows the waveforms of the ac side voltage and current; FIG. 2(b), (c) and (d) show the dc side voltage waveform when ΔP=0, ΔP>0 and ΔP<0, respectively. The trend lines are drawn by connecting Vdc(t) only at the moments of ac voltage zero-crossing points.

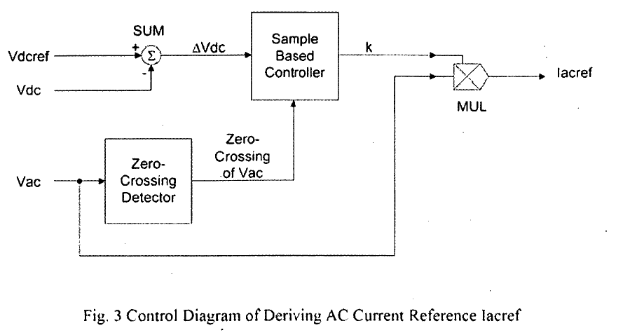

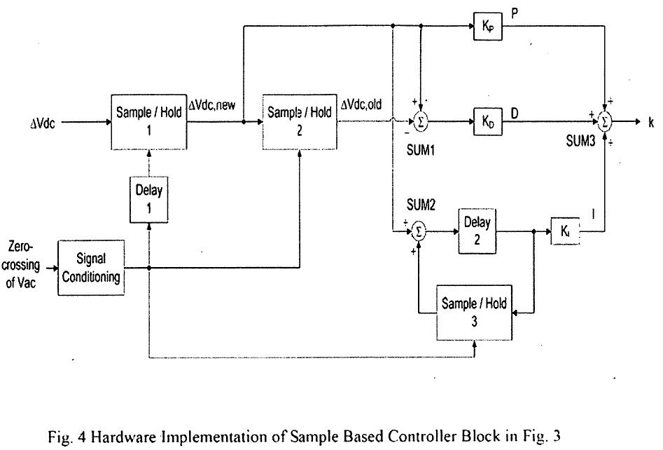

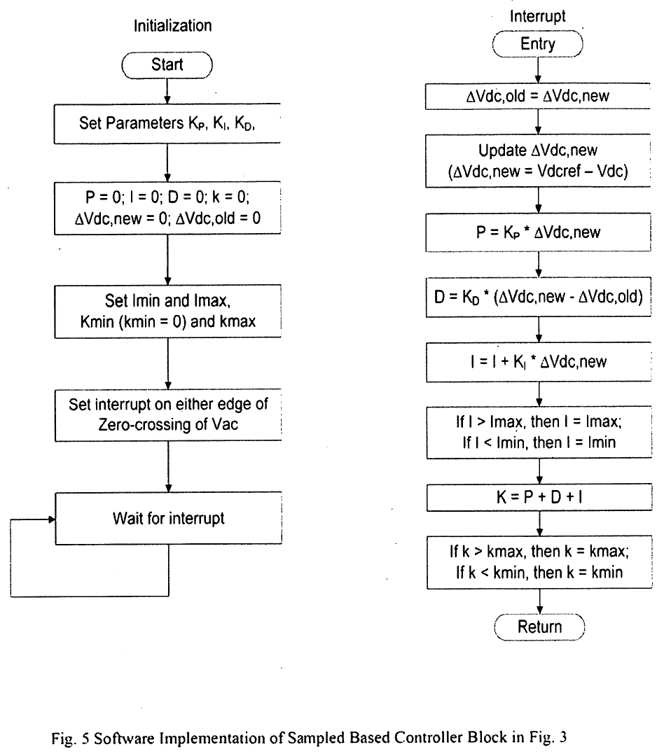

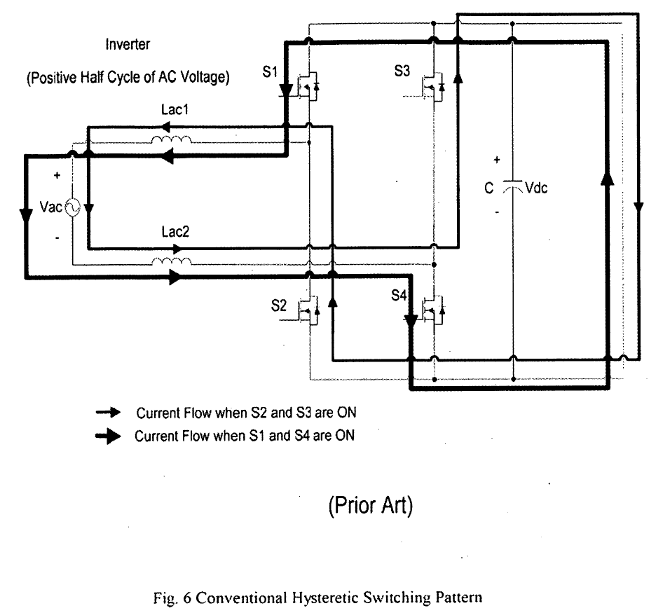

The derivation of the ac side current reference is based on the above analysis and the results shown in FIG. 2. The control diagram is shown in FIG. 3. The current reference Iacref is the product of the ac side voltage and a coefficient k. The coefficient k is derived from ΔVdc, which is the difference between the dc voltage reference and the actual dc voltage. The key point is that k is updated only at the zero crossing points of the ac input voltage. The controller which derives k is called ‘Sample Based Controller’, because it updates k once every half cycle.

The ‘Sample Based Controller’ block in FIG. 3 can be implemented either in hardware or in software. FIG. 4 shows a hardware implementation example.

In FIG. 4, the ‘Zero-crossing of Vac’ signal is from the ‘Zero-crossing Detector’ block in FIG. 3. It is a square waveform. Both rising and falling edges indicate a zero-crossing point of the ac voltage. The ‘Signal Conditioning’ block in FIG. 4 transforms the waveform into a pulsed logic signal. The signal is normally at low level. The rising and/or falling edges of the zero-crossing signal will trigger the logic signal to be high level for a short period of time, which is enough to activate the downstream sample/hold circuit. The pulse duration is in the order of micro-seconds.

‘Sample/Hold 1’ and ‘Sample/Hold 2’ blocks are used to get the new ΔVdc value and to keep the last ΔVdc value. It is important to have the ‘Delay 1’ block, so that the last ΔVdc value can be reliably sampled through ‘Sample/Hold 2’ block, to become ‘ΔVdc,old’ signal. So the timing of ‘Delay 1’ block should be designed to make sure that the starting of the sample period of ‘Sample/Hold 1’ is after the completion of the sample period of ‘Sample/Hold 2’.

K_{P}, K_{D} and K_{I} are gain blocks. This gives the options of using any one or any combinations of P, I, or D controller. ‘ΔVde,new’ is the present difference between the dc voltage reference and the actual dc voltage. This signal, is fed to gain block K_{P} directly for proportional controller output. The summing block ‘SUM1’ takes ‘ΔVdc,new’ and ‘ΔVdc.old’ as inputs, with ‘Δdc,new’ being positive, and ‘ΔVdc,old’ being negative. The result is fed to gain block K_{D} for differential controller output. It is important to have delay block ‘Delay 2’ and sample/hold block ‘Sample/Hold 3’ for a functional integrator. ‘Sample/Hold 3’ is used as a memory of the integration result from the last time. The zero-crossing signal will trigger ‘Sample/Hold 3’ block to feed the old integration value to one input of the summing block ‘SUM2’. The other input of ‘SUM2’ block is ‘ΔVdc,new’, so the output of ‘SUM2’ is the new integration result. The ‘Delay 2’ block is important to prevent the output, of ‘Sample/Hold 3’ block from changing. The timing of the delay block is a little longer than the completion of sample period of ‘Sample/Bold 3’ block. In this way, the output of ‘Delay 2’ block will remain unchanged for the rest of the half cycle, until the next zero-crossing of the ac voltage. Finally, the output is the coefficient k, which is the sum of P, I and D controllers. Since the output is updated once every half cycle, it is actually a discrete PID controller with sample time being half of the line cycle.

In FIGS. 3 and 4, all functional blocks are simple analog circuits. FIGS. 3 and 4 form the block diagram of a complete integrated circuit. The circuit can greatly reduce the development cycle of the system, improve the reliability, and lower the system cost.

The ‘Sample Based Controller’ block in FIG. 3 can also be implemented in software. FIG. 5 shows a software flowchart example.

In the initialization part, the gain values of K_{P}, K_{D} and K_{I} are given. All the inputs and outputs are cleared to 0. There should be software limits for the integrator output I and the overall output k. Set both edges of zero-crossing signal to be interruptable. Once a zero-crossing event happens, the interrupt part of the software is executed. In the interrupt software, the outputs of P, I and D controllers are calculated separately and then added up together to get the overall output k. With this method, only a low profile microcontroller is required, due to the low memory requirement, short execution time, and low interrupt frequency.

### Second Step: A New Current Mode Switching Pattern

The basis of the new switching pattern is the hysteretic control, in the conventional hysteretic switching pattern, the switches are controlled in pairs. FIG. 5 shows the current flow of an inverter during positive half cycle of the ac voltage. Refer to FIG. 1, S1 and S4 are always switched on and off at the same time; S2 and S3 are switched on and off at the same time. Whenever S1 and S4 are on, S2 and S3 must be off and vice versa. The logic is simple. However, there are two main disadvantages in this pattern. Firstly, a deadtime has to be inserted during the commutation between S1 and S2, and also between S3 and S4, to avoid the risk of shoot-through. Secondly, all the switches are commutated once in each switching cycle, which is not necessary and increases the losses.

The idea of the disclosed switching pattern is to reduce the number of switching events. In each half line cycle, only one switch is in PWM mode for both PFC circuit and the inverter.

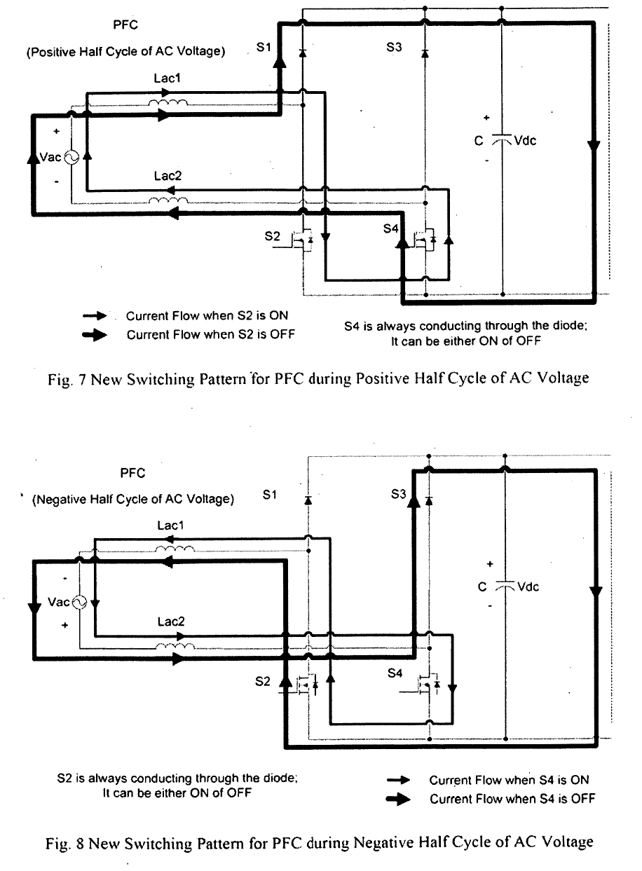

The current flow for positive and negative half cycles of one switching pattern example for bridgeless PFC is shown in FIG. 7 and FIG. 8, respectively. For a bridgeless PFC circuit, there are two diode and two controllable switches. In the positive half cycle, S2 is in PWM mode and S4 is kept off. In the negative half cycle, S2 is kept off and S4 is in PWM mode. Let a logical variable H represent the sign of the ac side voltage, i.e.,

H=0 when the ac side voltage Vac<0;
H=1 when the ac side voltage Vac>=0.

Define a hysteretic band ΔI (ΔI>0). Let a logical variable S represent the relationship between the actual current and the current reference as follows:

S=0 when Iac>Iacref+ΔI
S= 1 when Iac<Iacref−ΔI
S is not changed when Iac is between (Iacref−ΔI) and (Iacref+ΔI). According to FIG. 7 and FIG. 8, the switching logic equations of the switches can be written as;

S2=H·S (9)

S4= H̅· S̅ (10)

Where H̅ and S̅ are the logic inverse of H and S, respectively.

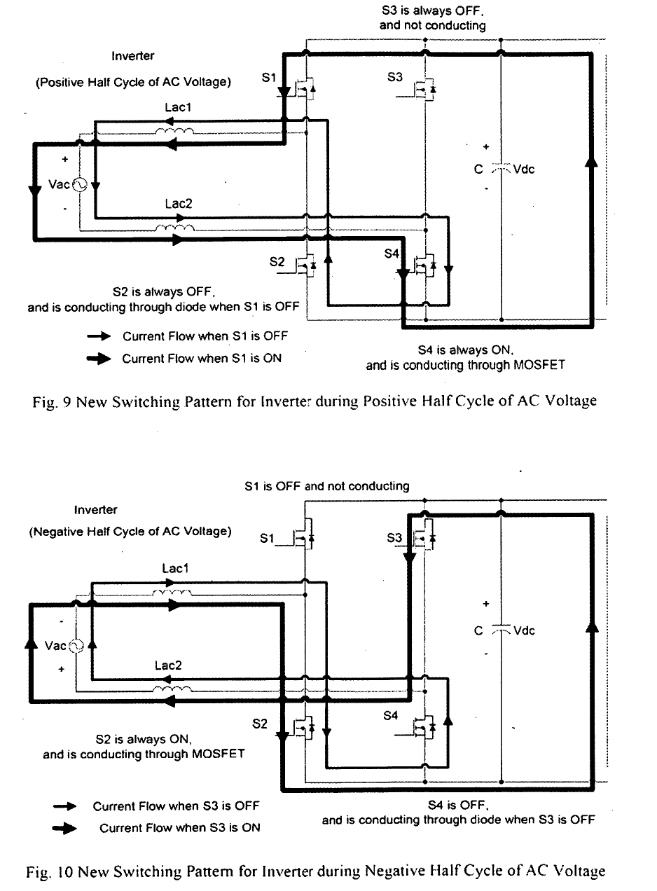

The current flow for positive and negative half cycles of one switching pattern example for the inverter is shown in FIG. 9 and FIG. 10, respectively. For an inverter, there has to be four controllable switches. Note FIGS. 9 and 10 have the same current path as in FIGS. 7 and 8, except; the reversal in the direction. In the positive half cycle, S1 is in PWM mode, S2 and S3 are kept off, and S4 is kept on. In the negative half cycle, S1 is kept off, S2 is kept on, S3 is in PWM mode, and S4 is kept off. The switching logic equations are:

S1=H·S (11)

S2= H̅ (12)

S3= H̅· S̅ (13)

S4=H (14)

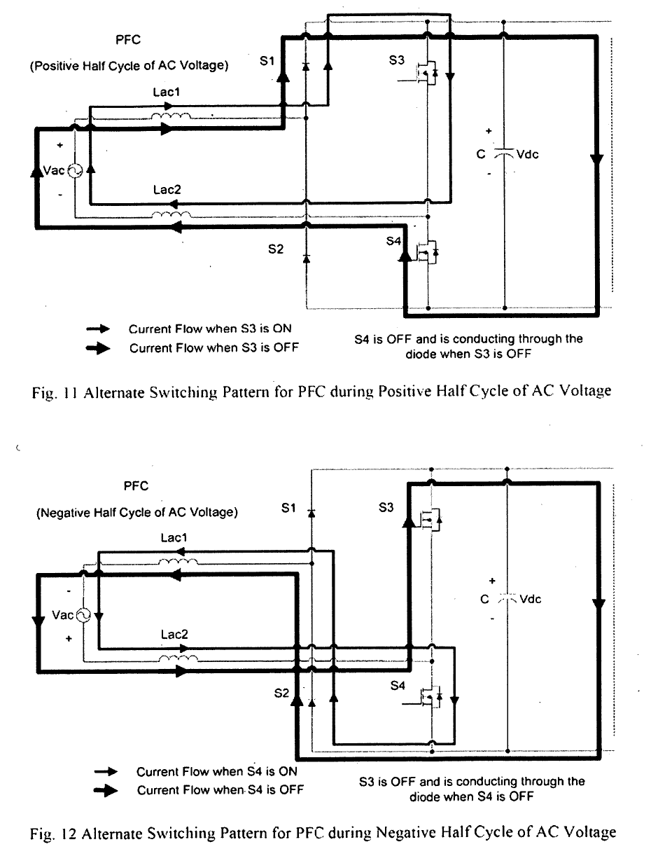

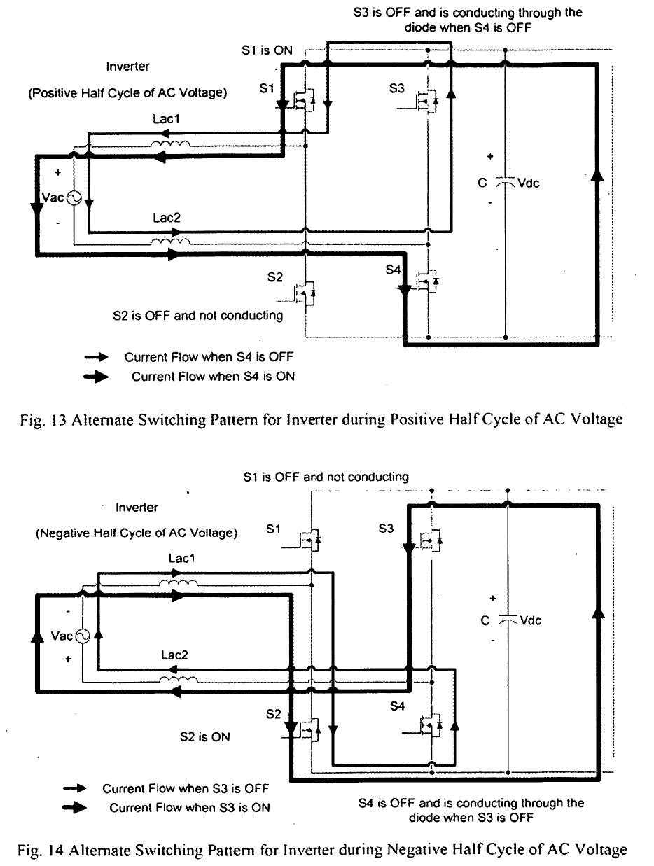

This method can be recombined to get up to four different switching patterns, due to the symmetric nature of the converter. Another example is shown in FIG. 11˜14 for another kind of current flow. For the power factor controller, instead of using S1 and S3 to be diodes, in this example, S1 and S2 are diode. For the inverter, instead of doing PWM on S1 and S3, in this example, S3 and S4 are in PWM mode. The resulting switching logic equations for the power factor controller are:

S3=H·S (15)

S4= H̅· S̅ (16)

The resulting switching logic equations for the inverter are;

S1=H (17)

S2= H̅ (18)

S3= H̅· S̅ (19)

S4=H·S (20)

Other combinations in power factor controllers include choosing S3 and S4 as diodes, or S2 and S4 as diodes.

When S3 and S4 are diodes in power factor controllers, the switching logic equations are:

S1= H̅· S̅ (21)

S2=H·S (22)

The corresponding switching logic equations for the inverter with the same current path are:

S1=H·S (23)

S2= H̅· S̅ (24)

S3= H̅ (25)

S4=H (26)

When S2 and S4 are diodes in power factor controllers, the switching logic equations are:

S1= H̅· S̅ (27)

S3=H·S (28)

The corresponding switching logic equations for the inverter with the same current path are:

S1=H (29)

S2= H̅· S̅ (30)

S3= H̅ (31)

S4=H·S (32)

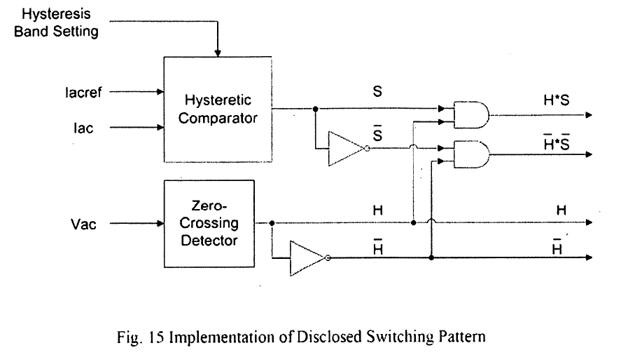

The switching pattern is based on hysteresis comparison and simple logics, so it can be integrated into one integrated circuit. One implementation example is shown in FIG. 15. The inputs to the circuit include the ac side voltage Vac, the ac current reference Iacref which is derived from the first step, the measured ac current Iac, and the optional external setting ‘Hysteresis Band Setting’. The outputs are the switching signals. Since there are so many combinations, the outputs are designed to be suitable for ail combinations. For power factor controllers, the output ‘H’ and ‘ H̅’ are not used.

Under this kind of switching pattern, for the bridgeless power factor controller, each controllable switch is in PWM mode for half cycle and in fully on mode for the other half cycle. For the grid connected inverter, one pair of the switches are switched at line frequency only. The other pair of the switches are in PWM mode for half cycle and in off mode for the other half cycle. All unnecessary switching events have been removed. This feature reduces the gate drive loss, which is a considerable reduction in the control power dissipation. There is no risk of shoot-through, so no deadtime is required. This is an important benefit, it not only improves the waveform by removing the distortion caused by the deadtime, but also improves the reliability.

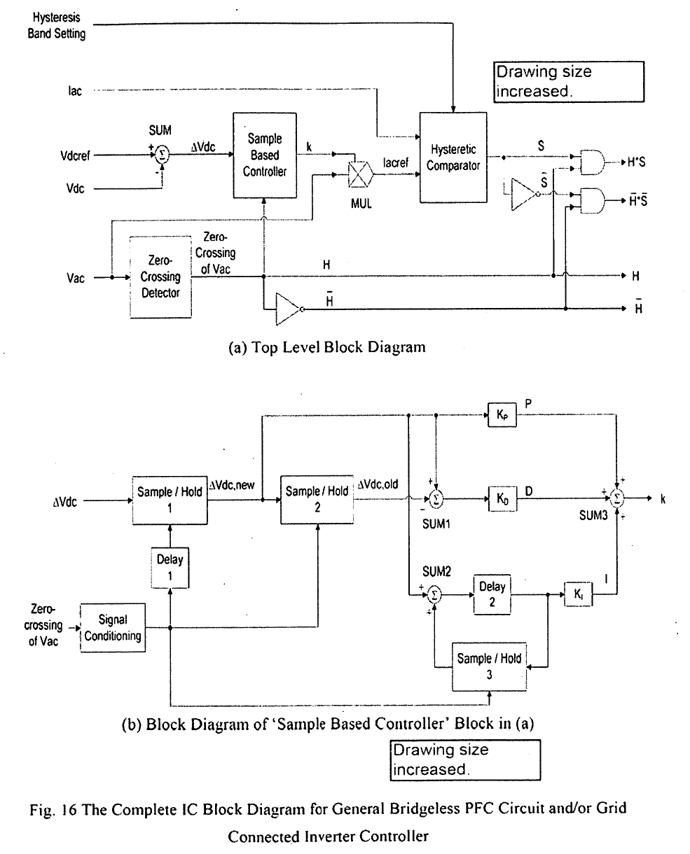

Finally, the two steps can be combined into one integrated circuit, as shown in FIG. 16. FIG. 16(a) shows the top level block, diagram which is a combination of FIG. 3 and FIG. 15. FIG. 16(b) shows the detail implementation of the ‘Sample Based Controller’ block, which is the same as in FIG. 4.

While exemplary embodiments described hereinabove, it should be recognized that these embodiments are provided for illustration and are not intended to be limitative. Any modifications and variations, which do not depart from the spirit and scope of the invention, are intended to be covered herein.

What is claimed:

1. A method and apparatus of controlling bridgeless power factor controllers and/or grid connected inverters. The bridgeless power factor controller contains two diodes and two controllable semiconductor switches. The grid connected inverter contains four controllable semiconductor switches. There are two steps in the said control method and apparatus:
The first step is to derive the ac current reference using ‘sample based control’ as its key element;
The second step is to control the ac current to the current reference according to the improved hysteretic switching pattern.

2. The apparatus of claim 1, wherein the derived ac current reference is proportional to the ac voltage, and the proportion coefficient is derived from the ‘sample based control’ block, and is updated once every half cycle.

3. The apparatus of claim 2, where in the ‘sample based control’ block is implemented in hardware. The circuit block diagram is shown in FIG. 4. The output of the block is the proportion coefficient k. It is updated once every half cycle, right at the zero-crossing point of the ac voltage. It utilizes delay circuits and sample/hold circuits to memorize the required values in the previous cycle, so that a discrete PID controller with sample time of half line cycle is implemented.

4. The apparatus of claim 2 and claim 3, where in the derived ac current reference is implemented in one integrated circuit. The complete blocked diagram is shown in FIG. 3 and FIG. 4.

5. The apparatus of claim 2, where in the ‘sample based control’ block is implemented in software, where the software flow chart is shown in FIG. 5. The software is triggered once every half line cycle.

6. The apparatus of claim 1, wherein the improved hysteretic switching pattern has only one switch operating in PWM mode in each half cycle. All other switches have a fixed state during half cycle.

7. The apparatus of claim 6, wherein the switching pattern is written in a series of logic-equations.

8. The apparatus of claim 7, wherein the logic equations include the following:
Define H=1 when Vac>=0
Define H=0 when Vac<0
Define S=0 when Iac>Iacref+ΔI
Define S=1 when Iac<Iacref−ΔI
The logic variable of H·S and H̅· S̅ are assigned to one and only one of the controllable switches in bridgeless power factor controller. There are four different ways of the assignments.
The logic variable of H̅, H, H·S and H̅· S̅ are assigned to one and only one of the switches in grid connected inverters. There are four different ways of assignments.

9. The apparatus of claim 8, wherein one way of the assignment is;
For bridgeless power factor controller,
S1 and S3 are diodes,
S2=H·S
S4= H̅· S̅
For grid connected inverters,
S1=H·S
S2= H̅
S3= H̅· S̅
S4=H
where S1, S2, S3 and S4 are defined in FIG. 1.

10. The apparatus of claim 8, wherein another way of the assignment is:
For bridgeless power factor controller,
S1 and S2 are diodes,
S3=H·S
S4= H̅· S̅
For grid connected inverters,
S1=H
S2= H̅
S3= H̅· S̅
S4=H·S
where S1, S2, S3 and S4 are defined in FIG. 1.

11. The apparatus of claim 8, wherein another way of the assignment is:
For bridgeless power factor controller,
S3 and S4 are diodes,
S1= H̅· S̅
S2=H·S
For grid connected inverters,
S1=H·S
S2= H̅· S̅
S3= H̅
S4=H
where S1, S2, S3 and S4 are defined in FIG. 1.

12. The apparatus of claim 8, wherein another way of the assignment is:
For bridgeless power factor controller,
S2 and S4 are diodes.
S1= H̅· S̅
S3=H·S
For grid connected inverters,
S1=H
S2= H̅· S̅
S3= H̅
S4=H·S

13. The apparatus of claim 6, wherein the switching pattern is implemented with comparator circuits and logic circuits, and is integrated into one integrated circuit. The block diagram of one example of the integrated circuit is shown in FIG. 15.

14. The apparatus of claim 1, claim 4 and claim 13, wherein the complete control circuit is integrated into one integrated circuit. The block diagram of one example of the integrated circuit is shown in FIG. 16.
